(19) United States
(12) Patent Application Publication
(10) Pub. No.: US 2025/0348680 A1
(43) Pub. Date: Nov. 13, 2025

(54) Recommendation of textual data in the process of acquisition

(71) Applicant: ORANGE, Issy-les-Moulineaux (FR)

(72) Inventors: Sonia Laurent, Chatillon (FR); Jean François Letellier, Chatillon (FR); Mickael Le Trocquer, Chatillon (FR)

(21) Appl. No.: 18/868,260

(22) PCT Filed: May 26, 2023
(86) PCT No.: PCT/EP2023/064274

§ 371 Date: Nov. 22, 2024

(30) Foreign Application Priority Data
May 31, 2022 (FR) FR2205195

(51) Int. Cl. G06F 40/30; G06F 3/04883; H04L 51/02

(52) U.S. Cl. CPC G06F 40/30; G06F 3/04883; H04L 51/02

(57) ABSTRACT

An information-processing device and a method for providing assistance in acquiring required textual data. The device: establishes a first semantic graph based at least on said required textual data; obtains textual data from data delivered by at least one source, and establishes at least a second semantic graph based on the obtained textual data; performs a search for an at least partial similarity between the first and second semantic graphs in order to identify at least part of the required textual data among the obtained textual data; and issues a recommendation on the basis of the identified textual data.

### TECHNICAL FIELD

This disclosure relates to the field of data processing by multiple computer applications.

### PRIOR ART

In everyday life, particularly professional and specifically in the context of “digital enterprise”, users require the execution of diverse digital processes. In particular, they may contribute to multi-application or multi-platform projects (the execution of which may require several applications (or platforms)).

For example, a user may be required to open an application, search for information useful for a common task, then open a second application and enter textual data by copying some of the information previously found.

In another example where a user is reading documentation or a message in a conversation, the user may trigger a parallel action in another business application in order to enter textual data related to the documentation or message viewed (or vice versa).

User management of these multiple applications can be tedious, and a computerized means for facilitating navigation between these applications is sought.

### SUMMARY

The present improves the situation.

To this end, it proposes a method implemented by an information-processing device, comprising:
obtaining textual data based on data delivered by at least one source (S2), and
issuing a recommendation relating to data required by at least one currently-running computer application with which at least one user interface of said device allows interaction, based on a semantic similarity between at least some of said obtained data and at least some of said required data.

In at least one embodiment, the method may comprise identifying at least part of the required textual data among the obtained textual data (S7), and said recommendation is based on the identified textual data.

In at least one embodiment, said required data are data currently being written by a user of said device.

In at least one embodiment, said recommendation comprises a proposal of elements that correct and/or complete said required data.

In at least one embodiment, said semantic similarity takes into account a similarity between a first semantic graph established for said obtained data and a second semantic graph established for said required data.

Thus, in at least one embodiment, the method comprises:
establishing a first semantic graph based at least on required textual data,
obtaining textual data from data delivered by at least one source, and establishing at least a second semantic graph based on the obtained textual data,
performing a search for an at least partial similarity between the first and second semantic graphs in order to identify at least part of the required textual data among the obtained textual data, and
issuing a recommendation based on the identified textual data.

Here, the term “establishing a semantic graph” is understood to mean a semantic (and not simply lexical) analysis which allows structuring the textual data into, for example, a tree structure. Thus, the aforementioned similarity search may include identifying one or more branches comprising common elements (nodes for example) in the first and second graphs. Establishing such graphs typically allows establishing a structure for the required textual data in order to easily identify the textual data from the source that may correspond to these required data.

The data delivered by the source are considered reliable and thus may constitute reference data. It is thus possible to complete and/or correct data from the first graph based on data from the second graph. The method then offers assistance to a user in easily entering reliable textual data, which may be required for example by an application in embodiments presented below.

In at least one embodiment, the method may then comprise:
establishing the first semantic graph based at least on textual data to be verified,
performing a search for an at least partial similarity between the first and second semantic graphs in order to identify at least part of the textual data to be verified among the obtained textual data, and
issuing a correction recommendation if data from the identified part differ from the corresponding obtained textual data.

Such an implementation may thus, at least in certain embodiments, assist for example with detecting errors in required data that typically is in the process of being entered, and may then recommend corrections for these errors.

As indicated above, the required data may be required, for example, by a currently-running computer application that is requesting the required data. In at least one embodiment, the method may then further comprise cooperating with such a computer application. For example, such an application may manage the presentation of an online form on an active web page, and thus will wait for (i.e. request) data to be entered by a user. According to another example, such an application may convert image data currently being captured by a camera into textual data (by optical character recognition). These images may represent, for example, characters on a sheet of paper (e.g. a paper form) or on a whiteboard, in particular handwritten characters, currently being entered by a user. For example, in this case it may be advantageous to implement a verification of the textual data already entered by the user in order to suggest corrections or even recommend new data to be entered.

To generate these recommendations, in one embodiment the method may comprise:
managing a human-machine interface that is connected to the information-processing device, and
sending a message via the human-machine interface, corresponding to said recommendation.

This message may lead to suggesting data to be entered, proposing to the user the textual data to be provided to said computer application. An example of such an embodiment is illustrated in FIG. 6 which shows a window that opens (in a “pop-up”) with helpful suggestions while the user is attempting to enter data, and if the user accepts the proposed suggestions, the online form is filled in with the required data.

Depending on the embodiments, the human-machine interface may be an interface integrated into the device or an interface coupled to the device via wired and/or wireless communication means.

Thus, in some exemplary embodiments, the human-machine interface may comprise a screen displaying at least a first window specific to the computer application, and the method comprises:
controlling a displaying of said recommendation in a second window on the screen, simultaneously with the first window.

Such an embodiment may, at least in certain embodiments, contribute to improving the ergonomics of the user interface, the recommendation being displayed for example “on top” of a window specific to the current application (for example transparently).

Additionally or alternatively, in some embodiments, the aforementioned recommendation may directly comprise the identified textual data, and the method comprises:
supplying the computer application with the identified textual data.

Thus, for example, the textual data required by the application are directly provided to the application, without user intervention. In the example illustrated in FIG. 6, the data for a destination city (“Rennes”) and a travel date (“Jan. 7, 2022”) are filled in directly in the online form. The user may of course correct this data later on, if necessary.

In this example in FIG. 6, the required data appears in an image illustrated in FIG. 2 which corresponds to an instant messaging chat for example. This image is considered here as a source of reference data and the online form to be filled in (accessible via a web page for example) in FIG. 3 corresponds to the application requesting the required data.

A semantic analysis of this required data may result in the first graph mentioned above and a semantic analysis of the chat in FIG. 2 may result in the second graph mentioned above.

In at least one embodiment, these first and second semantic graphs are tree structures and comprise:
nodes representing predicates, and
leaves representing textual data and being responses to the predicates.

The method may then comprise:
identifying nodes with common predicates between the first and second graphs, and
in the second graph, selecting leaves coming from the nodes with common predicates, said selected leaves corresponding to said part of the required textual data among the obtained textual data.

Thus, in such an embodiment, a search for common nodes is carried out in the graphs in order to deduce the leaves which come from these nodes in the second graph and which correspond to relevant responses, in order to provide the required data.

In the example of FIGS. 4 and 5, the common nodes under the d/date-entity branch corresponding to a future destination date may be identified. This date of the second graph in FIG. 4 gives the response to the required data under the same nodes of the first graph in FIG. 5. Thus, the date (for example the default date) of Feb. 10, 2022 of the first graph must be corrected to the date of January 7 given by the second graph.

For example, these first and second semantic graphs may be in Abstract Meaning Representation (AMR) computer language.

The data delivered by the sources may be in different forms. For example, these may be image data containing text, and the method may then comprise:
processing these image data by character recognition in order to obtain textual data.

The reference textual data may therefore originate from an image such as a digital photograph, or a digital video, in any format.

Additionally or alternatively, in some embodiments, data delivered by a source may be audio data, and the method may comprise:
processing said audio data in order to detect speech signals and convert the speech signals into textual data.

In this case, the reference textual data is derived for example from an audio recording.

Additionally or alternatively, in some embodiments, data delivered by a source may come from a computerized device for capturing handwritten characters, and the method may comprise:
implementing character recognition for handwritten characters in order to convert the entered characters into textual data.

For example, here the reference textual data may come from a connected whiteboard or a graphics tablet with handwritten character recognition, or some other source.

Additionally or alternatively, in some embodiments, the required textual data may themselves come from an analysis of image data of the aforementioned type, or from audio content, or from a file acquired by handwritten character recognition.

Of course, the reference data and/or the required data may come from editable text files (for example in “doc” or “docx” format) or from non-editable text files (for example in “pdf” format). In one embodiment, at least part of the obtained textual data may be stored in the memory of the information-processing device along with data concerning the type of source from which they were delivered. Thus, for example, in the event of a conflict between the respective responses given by different sources, certain reference data (non-editable for example) may “take precedence” over others (for example over editable text which typically may contain input errors). According to another example, reference data from a trusted source, such as an official source (for example an institutional or government site) may take precedence over other reference data from any source.

In one embodiment, the data delivered by at least one source are stored in the memory of the information-processing device for a first period of time (which may be selected and for example be configurable) following the latest use in implementing the method.

Such an embodiment allows keeping the most frequently consulted data in memory (in a buffer for example) and erasing reference data which have not been used since the first period of time mentioned above.

In one embodiment, the method may comprise the implementation of artificial intelligence programmed to learn relevant recommendations on the basis of user feedback, and, after learning, to select a relevant recommendation to be issued on the basis on the identified textual data.

Thus, for example, if several leaves are possible when there are more than two graphs to compare, artificial intelligence can help to immediately eliminate the leaves corresponding to recommendations that would be rejected by the user.

According to another aspect, a computer program is provided comprising instructions for implementing all or part of a method as defined herein when this program is executed by a processor. According to another aspect, a non-transitory computer-readable storage medium is provided on which such a program is stored.

According to another aspect, an information-processing device is provided comprising a processing circuit configured for implementing the method according to this invention.

### BRIEF DESCRIPTION OF DRAWINGS

Other features, details and advantages will become apparent upon reading the detailed description below, and upon analyzing the attached drawings, in which:

FIG. 1 illustrates an example of a method according to one possible embodiment.

FIG. 2 illustrates an example of a reference data source for establishing a “second graph” as defined above.

FIG. 3 illustrates an example of a data acquisition context, here an application that is executing and is requesting textual data.

FIG. 4 illustrates a “second graph”, established from the source illustrated in FIG. 2.

FIG. 5 illustrates a “first graph” (as defined above), established from the data required in the context of FIG. 3.

FIG. 6 illustrates an interface management for providing a recommendation to a user.

FIG. 7 illustrates an example of an information-processing device for implementing the method.

### DESCRIPTION OF EMBODIMENTS

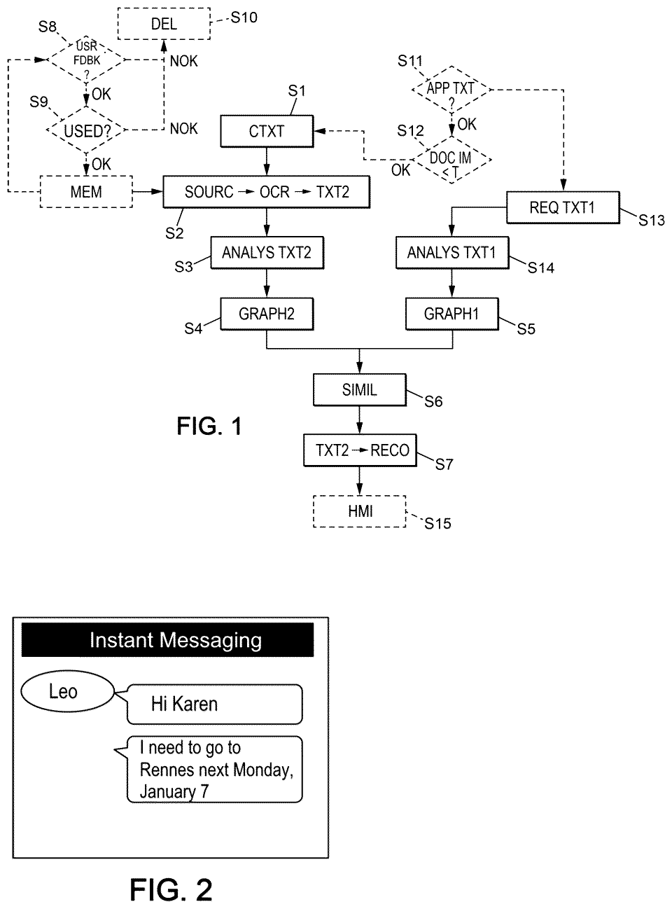

FIG. 1 illustrates, by way of example and in a non-limiting manner, an implementation of the method that is the object of the present application, by an information-processing device. With reference to FIG. 1, during a first step S1, a context of use is detected. This context may be detected for example if an application requiring textual data is currently running (test in step S11) and for example if the user of the device has recently viewed or is still viewing a document (test in step S12). This document may be text in a non-editable format (such as “pdf” for example), or a digital image, or text in an editable format, etc. Here, “recently” is understood to mean that the viewing of this document occurred less than an hour ago for example, or less than a few days, depending on the relevance of the document (as presented below with reference to steps S8 and S9).

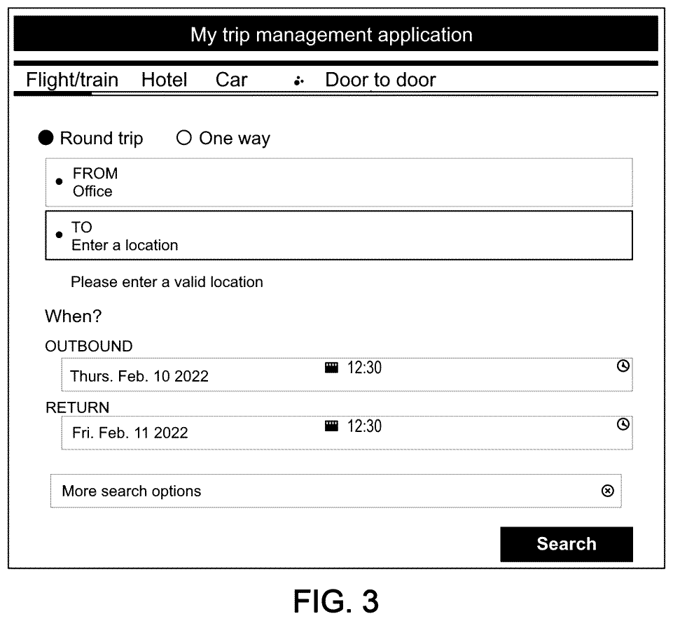

In this example, a user may enter textual data as part of the execution of the application in step S11. For example, this application may pose questions via a human-machine interface of the device, and user responses are expected to be entered. As an example, this may be an online form to be filled out by the user, as presented below with reference to FIG. 3. Thus, textual data (TXT1) are required by the application in step S13.

Of course, the determination of this context in steps S11 and S12 is an optional example and is therefore represented by dotted lines. In one variant, the user may for example write information on a whiteboard or on a blank sheet of paper, and a camera (for example on smart glasses) captures the information being written. This context may also be identified within the meaning of step S1 and a recognition of characters written on the sheet or board may be carried out in order to:
determine textual data currently being written by the user, and
identify whether such data can be corrected (for example a form filled in by hand by a user as in one exemplary embodiment presented below) or simply completed.

Thus, still in such an embodiment, textual data are required within the meaning of step S13 in order to be able to perform a verification and possibly a correction of the data currently being entered or a completion of the data currently being entered. This verification and/or completion of the data currently being entered may be carried out on the basis of reference textual data, as explained below.

Referring now to step S2 of FIG. 1, reference textual data TXT2 comes from one or more sources (other than the application currently being executed for example). For example, these sources may be files stored at least temporarily in a memory MEM of a device according to the present description, or web pages recently (or frequently) viewed by the user. For example, files (image files containing text, or editable text files, or other files) may be stored in a dedicated memory area for access by the method described here, in order to identify textual data TXT2 therein that can be used as reference data. In the case of an image file for example, character recognition may contribute to determining whether the textual data resulting from conversion of the image to text may be used as reference data. Optionally, these files (or links to these files) may be stored in the aforementioned memory area with indexing concerning the nature of data that may be used, for example:
data specific to the user's identity (data from a user identity document, or social security number, or other data),
data acquired in a professional context,
etc.

Referring now to step S14 of FIG. 1, a semantic analysis of the questions asked during the execution of the application, or of textual data being written by the user, allows creating a semantic graph in step S5. This semantic graph GRAPH1 may be for example in the form of a tree in an abstract semantic representation, for example in “AMR” (“Abstract Meaning Representation”). Recall that AMR is a computer language for semantic representation. AMR graphs can represent one or more entire sentences. AMR differs from syntactic analysis in that different sentences with similar meaning can have the same AMR graph, even if they are not expressed in the same way. A tree graph, in particular an AMR graph, then comprises nodes and leaves, the leaves being answers to questions represented by the upstream nodes (or “predicates”). For example, “5:30 p.m.” may be a leaf of the predicate node “at what time?”.

Thus, in the embodiments detailed, the establishment of graph GRAPH1 can make it possible to establish a structure of the required textual data in order to identify the textual data from the source that may correspond to the required data. Indeed, after establishing this graph GRAPH1 in step S5 of FIG. 1, the method also proposes a semantic analysis of reference data TXT2 in step S3, as well as the establishment of a semantic graph GRAPH2 of the same nature (for example AMR) in step S4, based on these reference data. The selection of a source in step S2 may also depend on the required textual data if the files corresponding to the different sources are indexed in memory according to particular topics. For example, the files relating to the topic “user identity” may be selected and semantically analyzed (after possible conversion into textual data), if predicates of graph GRAPH1 of required data TXT1 correspond to this topic (asking the question “social security number?” for example).

Step S6 then consists of comparing the two graphs GRAPH1 and GRAPH2 in order to identify similarities, particularly at the predicates. For example, if common nodes are identified between the two graphs, the leaves of second graph GRAPH2 which come from these nodes may be answers to questions formulated in the predicates of first graph GRAPH1. These answers may therefore correspond to the required textual data in step S13. At the end of this step S6, reference textual data TXT2 may thus allow formulating recommendations in step S7 which are aimed at answering the questions of first graph GRAPH1, or possibly at correcting leaves of first graph GRAPH1. In at least some embodiments, these recommendations in textual data form may be fed directly to the application being executed (without user intervention), or may be presented to the user in step S15.

In this step S15, for example in an application where the user fills out a form (online on a web page, or by hand on a sheet of paper), a human-machine interface may be managed to display on a screen a window presenting text corresponding to the recommendation (transparent overlay or next to the form in the web page, or on the lenses of smart glasses in augmented reality when the user is writing on a sheet or a whiteboard). Additionally or alternatively, the human-machine interface may include an audio headset and a recommendation message may be played on this audio headset (the message indicating for example the required textual data or a recommendation to correct text entered by the user).

The reference data delivered by the aforementioned sources in step S2 thus make it possible to assist with the data entry required by an application or by the user during an activity of entering such data (this assistance may be provided via the management of said human-machine interface).

The sources providing these reference data may be stored for this purpose in memory, as indicated above. However, to avoid overloading the memory and/or to avoid proposing irrelevant reference data, a test may be conducted in step S8 to determine whether the user confirms the recommendation by entering the required data. If such is not the case, the references of the file as a source of reference data may be deleted from the memory in step S10. For example, artificial intelligence may be implemented to determine the data sources to be retained and which may be relevant, by learning from the recommendations confirmed by the user. Additionally or alternatively, in step S9, if a source has not been used for a threshold period of time (for example a few days or more), the reference to this source may be deleted from the memory in step S10.

Thus, such an implementation may in particular assist the user with entering data, by directly supplying data to the application requiring this data (the user being able to verify for example that the data filled in directly in an online form without user intervention are correct), or by offering the management of a human-machine interface. An improvement is thus proposed (for example an optimization) of the interactions between applications that a user may use by positioning information for example “above” (along a Z axis “of a display screen” as illustrated in FIG. 6 presented below), or next to it (along the X, Y axes) or more generally by superimposing information in the case of augmented reality glasses, combining and linking the information that is useful to the user's activity.

The actions between applications are assumed to be interconnected, for example according to preferential rules that the user sets in the aforementioned computer program (and which may be refined by artificial intelligence learning). The application of these rules may take place, for example, after detecting words or sentences visible on the screen (independently of the application currently being used). Thus, computer modules such as an optical character recognition (“OCR”) application, an abstract meaning representation (“AMR”) computer application, a computer program for identifying similar predicates in graphs and searching for response leaves, may be implemented.

Examples of techniques for identifying an acquisition context within the meaning of step S1 are presented below, with the aim of proposing, for example, the management of a human-machine interface within a context of assembling the required data.

A multi-source assistance module may be provided, requiring inputs from a context analysis module (“context analyzer”). A first functional block identifies, for example on the user's screen(s), the applications currently being used. If this is an implementation in an augmented reality environment, the first functional block identifies the real or virtual areas that have the user's attention. This identification may be carried out by eye tracking, and/or by tracking the taps on a touch surface (pad), and/or by tracking another input interface such as a mouse (mouse tracking), or more generally by tracking system events.

This step makes it possible, for example, to extract images from the application areas being observed by the user or to produce such images.

For a user who is regularly observing two separate applications (for example with successive focusing on the two applications and/or an observed movement of the user's gaze detected by matching to the X, Y positions of the applications present on the screen) and over a configurable period of time, two images are therefore copied and associated with this period of time T (for example according to test S12 presented above).

FIG. 2 illustrates an example of an application in which a user of an instant messaging application indicates to a correspondent his desire to go to a city on a certain date. At the same time, he accesses another application for making online reservations to travel to that city, as in FIG. 3. Two images are then generated, corresponding to FIGS. 2 and 3.

Of course, the scope of application of the method may extend to a virtual reality or augmented reality context. For example, augmented reality glasses can observe and represent a (real) whiteboard and implement a method of recognizing handwritten characters on this board based on acquisition of a real image of this board. A television screen that reproduces information may also be the subject of image acquisition. It is thus possible to achieve service composition in a mixed reality world (virtual/real).

Optical recognition of the characters present in the images thus copied may be performed, as well as a precise analysis of the characteristics of these text areas (to identify an editable area versus a label, for example). Character retrieval may be carried out for example via a request intended for the operating system of the information-processing device used, or, in order to identify an editable area, via analysis of the appearance of a mouse pointer when hovering over the area containing the characters (for example, the mouse pointer is no longer a simple arrow when over an editable area), or via the appearance of the area itself (for example with or without a border, a different background color, or other distinguishing feature).

The example in FIGS. 2 and 3 concerns full text fields, but it is also possible to access text content coming from more complex components such as a drop-down list, a radio button with different headings depending on the position of the button, or other possibilities.

The visible texts may then be extracted from the images. Their positions in the images may be stored in memory. A semantic analysis of the visible texts is carried out in order to establish a semantic graph for each image.

For example, in the cases of FIGS. 2 and 3, in image 1 corresponding to FIG. 2: “I need to go to Rennes next Monday, January 7”, the text attributes may be “position 11: X, Y/non-editable text (=NE)”.

In image 2 (FIG. 3), the text attributes are:
“my trip management application” at position 12: X,Y (NE),
“flight/train” “hotel” “car” “door to door” at position 13: X,Y,
“round trip” “one way” at position 14: X, Y,
“from office” at position 15: X,Y
“To Enter a location” at position 16: X, Y
“When?” at position 17: X, Y (NE)
“Outbound” at position 18: X, Y (NE)
“Thursday, Feb. 10, 2022” at position 19: X,Y
“12:30” at position 110: X,Y, etc.

A semantic graphical representation of the extracted texts may for example be carried out using the Abstract Meaning Representation (AMR) technique. Other techniques for graphically rendering the meaning of sentences may also be used.

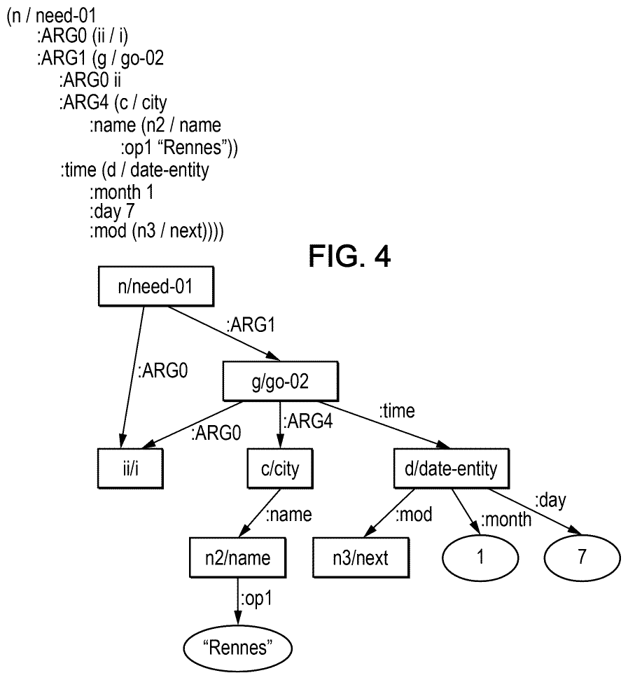

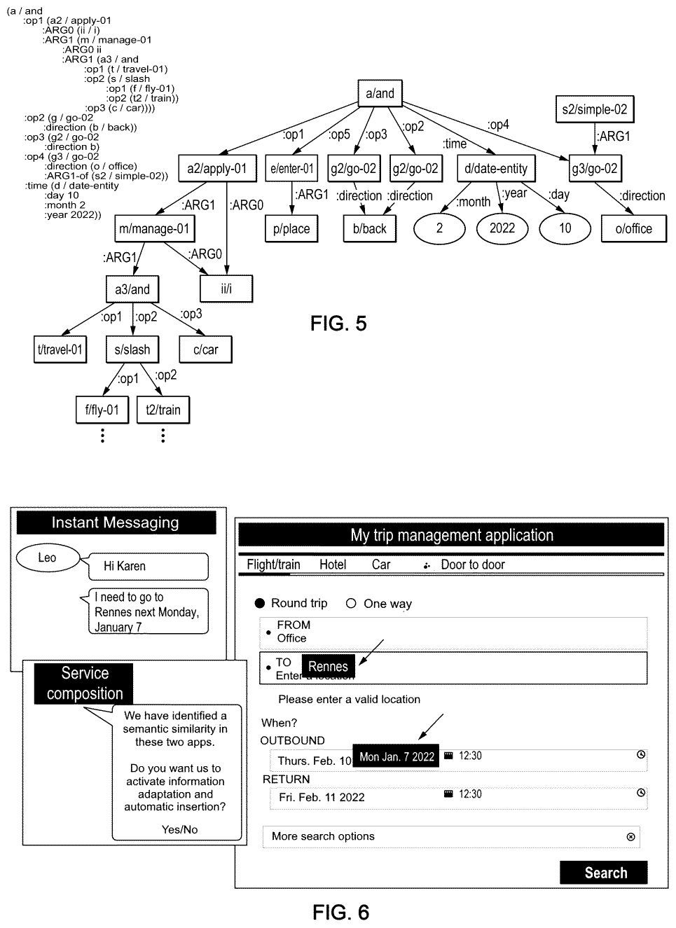

The semantic graph shows topics and arguments in a tree as illustrated as an example in FIG. 4. The tree in FIG. 4 corresponds more precisely to the semantic representation of image 1 in FIG. 2. For at least one node of the tree (for example for each node), attributes such as the X/Y position of the text and its characteristics (editable or non-editable text) may also be stored in memory.

The text extracted from Image 2 may be: “my trip management application” “flight/train hotel car” “door to door” “round trip/one way” “from office” “position A” “enter a location” “When? Outbound” “Thursday Feb. 10, 2022” (this last indication being the default for example).

In some contexts, the graphs produced may be very similar and simply comparing the graphs may reveal matches between data from images 1 and 2 being displayed on the screen. However, in some cases, the predicates may be different but still semantically close. For example: “t/travel” and “g/go” are close in their arguments (“start point”, “end point”, “traveler”, “goer”) (where the argument “goer” represents an entity in motion).

However, in some embodiments, it may be proposed to provide prior programming identifying general similarities between predicates so that a similarity of AMR predicates can be identified between two graphs in order to make a match between information from these respective graphs.

Thus, a graph GRAPH1 corresponding for example to an editable area on the screen of the device (for example the form in FIG. 3) may thus be completed (at least partially) by elements of one or more other graphs GRAPH2 (“input” elements) of data from other sources (for example the recent chat in FIG. 2). These elements thus may be proposed in a recommendation. This recommendation may be displayed for example in the form of a window that opens on the user's screen (management of the human-machine interface in step S15 above), “on top of” the other windows as illustrated in FIG. 6, in order to propose these elements to the user and, if the user accepts them, to use these elements to fill in the data required in the current application (“Rennes”, “Monday, Jan. 7, 2022”). The text proposed in the semantic context may be entered directly into the application if the user agrees with the recommendation made (i.e. if the device's understanding of the task to be performed seems correct to the user).

The user interface window that opens may, for example, be positioned over the other active windows and as close as possible to the applications concerned, for example in a transparent manner, as illustrated in FIG. 6. A sound interface may also be managed, additionally or alternatively, (with speech synthesis for example) to guide the user in entering numbers for example or to spell a city, etc.

The recommendations may also be established by making use of a learning module. For example, if the action proposed in the created interface is indeed executed (therefore confirmed by the user), it may then be submitted again in future uses. A recommendation window may also be opened when the semantic links have been confirmed, typically in previous uses.

In another use case below, corrections are recommended to the user after the user has entered textual data.

In this scenario, which here involves mixed reality, the user has augmented reality glasses. Such glasses are equipped with a camera module capable of capturing an image that the user is looking at, and of analyzing this image, in particular to detect written characters (typically). For example, the user looks at a health insurance card for a few seconds. The above method may be implemented to convert the captured image data into textual data by character recognition. The following information is thus extracted for example:
“health insurance card: 290042216205897”, and
“issued on Aug. 9, 2002”.

Semantic graph GRAPH2 of these reference data allows identifying leaf 290042216205897 as corresponding to a predicate of type “n/number”.

Next, the user fills out an online form that asks: “Please enter your health insurance card number: XXXXXX”. In doing so, however, the user erroneously enters: “290042216205889.”

Semantic analysis of the question asked establishes a graph GRAPH1 in which the expected response follows the predicate of type “n/number”. However, the response entered by the user does not match the response in reference graph GRAPH2 which follows the predicate of the same type in a similar branch.

An error is thus detected in the entered number and a pop-up window warns the user through a graphical interface (with a recommendation message superimposed as close as possible to the erroneous information). Additionally or alternatively, a sound interface may emit an error message (for example a beep or a voice message providing the recommendation, in this case the valid number) on an audio headset, according to the user's preferences.

The above method may thus be applied in different environments, in particular entirely digital work environments and/or in virtual or augmented reality, and may offer assistance, in at least one embodiment, in the use of at least one application. For example, the method may assist users in combining different applications to complete a task. In particular, the implementation of the method, as illustrated in the above use cases, may be carried out in real time and provide a dynamic, contextual aspect of the managed data (unlike “cold data”). Furthermore, at least in certain embodiments, the sources used (step S2) may impart a local aspect to the execution of the method (for example without the use of internet data, if needed), therefore offering advantages in terms of data protection (or privacy) unlike using a shared knowledge base for example, and does so based on the user experience that is in progress on a device such as a terminal (typically).

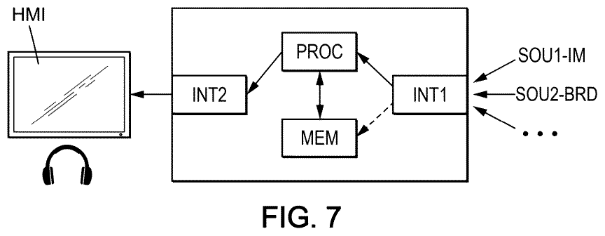

FIG. 7 illustrates an example of an embodiment of such a device DEV, for implementing the method defined above, which typically may include a processing circuit equipped with at least:
a first interface INT1, for receiving reference data (for example in the form of image files, or data from a connected whiteboard, or other data) delivered from different sources (SOU1, SOU2, etc.), these data being storable in memory MEM, at least temporarily,
a processor PROC and the memory MEM, this memory MEM further being able in particular to store instruction code data of a computer program within the meaning of this disclosure, the memory being accessible by processor PROC in order to read the instruction code and execute the method presented above, and
a second interface INT2 controlling a device of a human-machine interface HMI such as a screen (for opening recommendation windows) and/or an audio headset, or other.

Please amend the presently pending claims as follows:

1. A method implemented by an information-processing device, comprising:
obtaining textual data based on data delivered by at least one source, and
issuing a recommendation relating to data required by at least one currently-running computer application with which at least one user interface of said device allows interaction, based on a semantic similarity between at least some of said obtained data and at least some of said required data.

2. The method according to claim 1 comprising an identification of at least part of the required textual data among the obtained textual data, and wherein said recommendation is based on the identified textual data.

3. The method according to claim 1, wherein said required data are data currently being written by a user of said device.

4. The method according to claim 1, wherein said recommendation comprises a proposal of elements that correct and/or complete said required data.

5. The method according to claim 1, wherein
said semantic similarity takes into account a similarity between a first semantic graph established for said obtained data and a second semantic graph established for said required data.

6. The method according to claim 1, comprising:
establishing the first semantic graph based at least on textual data to be verified,
performing a search for an at least partial similarity between the first and second semantic graphs in order to identify at least part of the textual data to be verified among the obtained textual data, and
issuing a correction recommendation if in response to data from the identified part differing from the corresponding obtained textual data.

7. The method according to claim 1, comprising:
managing a human-machine interface that is connected to the information-processing device, and
sending a message via the human-machine interface, corresponding to said recommendation.

8. The method according to claim 7, wherein the human-machine interface comprises a screen (HMI) displaying at least a first window specific to the computer application, and the method comprises:
controlling a displaying of said recommendation in a second window on the screen, simultaneously with the first window.

9. The method according to claim 1, wherein the recommendation comprises the identified textual data, and the method comprises:
supplying the computer application with the identified textual data.

10. The method according to claim 1, wherein the first and second semantic graphs are tree structures and comprise:
nodes representing predicates, and
leaves representing textual data and being responses to the predicates, the method comprising:
identifying nodes with common predicates between the first and second graphs, and
in the second graph, selecting leaves coming from the nodes with common predicates, said selected leaves corresponding to said part of the required textual data among the obtained textual data.

11. The method according to claim 1, wherein said first and second semantic graphs are in abstract semantic representation computer language, or Abstract Meaning Representation (AMR) computer language.

12. The method according to claim 1, wherein said data delivered by at least one source are image data containing text, and the method comprises:
processing said image data by character recognition in order to obtain textual data.

13. The method according to claim 1, wherein said data delivered by at least one source are audio data, and the method comprises:
processing said audio data in order to detect speech signals and convert the speech signals into textual data.

14. The method according to claim 1, wherein said data delivered by at least one source are data delivered by a computerized device for capturing handwritten characters, and the method comprises:
implementing character recognition for handwritten characters in order to convert the entered characters into textual data.

15. The method according to claim 1, wherein said data delivered by at least one source are stored in a memory of the information-processing device for a first period of time following a latest use in implementing the method.

16. The method according to claim 2, comprising implementing artificial intelligence programmed to learn relevant recommendations on the basis of user feedback, and, after learning, to select a relevant recommendation to be issued on the basis on the identified textual data.

17. A non-transitory computer-readable storage medium storing a computer program comprising instructions which, when executed by a processor, cause the processor to perform a method comprising:
obtaining textual data based on data delivered by at least one source, and
issuing a recommendation relating to data required by at least one currently-running computer application with which at least one user interface of said device allows interaction, based on a semantic similarity between at least some of said obtained data and at least some of said required data.

18. An information-processing device, comprising:
at least one processor; and
at least one non-transitory computer readable medium storing a computer program comprising instructions which, when executed by the at least one processor, cause the information-processing device to perform a method comprising:
obtaining textual data based on data delivered by at least one source, and
issuing a recommendation relating to data required by at least one currently-running computer application with which at least one user interface of said device allows interaction, based on a semantic similarity between at least some of said obtained data and at least some of said required data.
